(19) United States
(12) Patent Application Publication
(10) Pub. No.: US 2005/0198878 A1
(43) Pub. Date: Sep. 15, 2005

(54) Redefined use unattached minimal assembly glass and crystal thing holder arrangement

(76) Inventor: Hortense Howell-Barber, Riverdale, NY (US)

Correspondence Address: Hortense Howell-Barber, 5900 Arlington Avenue, Apt. 1U, Riverdale, BX, NY, 10471, US

(21) Appl. No.: 10/797,389

(22) Filed: Mar. 10, 2004

(51) Int. Cl. G09F 19/12

(52) U.S. Cl. 40/427

(57) ABSTRACT

A method that elevates, orients, and immobilizes decorative glass items in an arrangement using crystal containers provides displays, decoration, and ornamentation. Containers may be stacked to provide variability. An assembly cushion helps to orient containers for more variety in the displays.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to display apparatus, specifically to displays that allow the maximum amount of available light to pass through or reflect from decorative glass items.

### BACKGROUND OF THE INVENTION

While accumulating over 200 decorative glass items from well-known paperweight artists and glass studios, I purchased several types of display apparatus. Many come with annoying disadvantages. The most annoying was that they interfered with the optical environment of the decorative glass item. I decorated with glass because I wanted the benefits of the best optical effects.

Because of the problematic and hodge-podge nature of the display apparatus, I eventually stopped collecting paperweights. The types of problems I encountered are described in the remainder of this section.

In a display case with see through shelving, the glass was tempered for additional strength. This introduced a generally green or gray tint to the items on the shelf. For example, see U.S. Pat. No. 4,865,402 to Walter (1989). Any solid table, stand, or shelf blocks light from beneath, and just as with tempered glass, it imparts the color of the support surface to the glass item. Another limitation was that on shelving, the items could only be displayed vertically unless an additional method was used.

A compartmentalized display case may block light from at up to five directions. If the case is freestanding, extra care must be taken to ensure that it does not become top-heavy. See U.S. Pat. No. 6,089,685 to Ryan, et al. (2000) for a particularly flexible example. Nevertheless, light is still blocked from the bottom, the back, and at least one side of each item place on one of the shelves. Again, the item may only be displayed vertically.

I owned dozens of plastic easels. Though the adjustable plastic easel, U.S. Pat. No. 3,999,734 to Gibson, et al. (1976) allowed display of more sizes of items than fixed easels, the adjustable easel was still too large for all of my decorative glass marbles. With the fixed easel, I had to select a size that goes with the item being displayed. Only the smallest fixed easel would support my glass marbles. Both fixed and adjustable easels tend to flip over when larger dense items are placed on them. As a result of these limitations, 50 percent of my glass items would not fit on either the adjustable easel or the three sizes of fixed easel.

Plastic, metal, wood, and mineral rings share the same problems as easels, and they tend to work only with globular shapes. If the globe is too large, it rolls off the ring, and if it is too small, it rolls around within the ring. There is still the issue of light being blocked from below. Elevated rings allow light from beneath, but they still have size restrictions and there is always a band of the displayed item that is not visible.

As shown in U.S. Pat. No. 6,142,315 to Arout (2000), a solid terraced system allows flexibility in the size and number of items is may display, but still blocks light from at least two directions.

Wire and clear plastic terraced stands allow light from all directions. However, care must be taken to ensure that they do not become top-heavy.

I have a display with lighting behind the glass items, similar to U.S. Pat. No. 6,283,608 to Straat (2001). It needs balanced lighting in front of the glass case to show items to best advantage. This balance is difficult to achieve because glare becomes a factor. The need for electrical connections causes multiple stand-alone displays to can become cumbersome and hazardous without special electrical connections.

Hollow acrylic stands and solid acrylic cubes allow light from all directions, though the light is distorted more than with crystal. Older, scratched stands cause greater distortion and look really out of place, especially when used to display really expensive glass or crystal items.

Mirrors reflect light from below or behind, but they only work for items with flat bottoms, and are not useful for marbles, eggs, or globes.

Crystal stands with one concave surface are currently limited to the number of shapes they can support. Because they are designed to hold globular forms, items without circular bases do not balance properly within the concavity. If inverted, the small square based is limited in the size of items it can safely support.

### BACKGROUND OF INVENTION—OBJECTIVES AND ADVANTAGES

I found a method of displaying decorative glass items that eliminates most of the display problems associated with prior art by accident.

It started when I discovered that glass crystal containers handle light so brilliantly that they display themselves well, without additional apparatus, wherever I found a place to set them. The hundreds of unique shapes were irresistible. They are usually one-fourth to one-third the price of paperweights of equivalent quality.

I started collecting glass crystal candlesticks and candleholders, even though I am pathologically afraid of burning candles in my home. Whenever candlesticks and candleholders came packaged with candles, I toss the candles.

I added other glass crystal containers to the collection, comprising vases, bowls, and glasses, and coasters after I exhausted the styles of candle accessories available from local dealers. Henceforth, references to containers will include candle accessories.

I managed to accumulate over 100 pairs in six months, but 80 pairs were stored in boxes because of lack of space. To reclaim space, I considered offering both decorative glass items and glass crystal containers for online auction.

While sorting my inventory on a Saturday morning, I was considering a small inexpensive paperweight in one hand and an unassuming votive candleholder in the other when the phone rang. Rather than try to find a place for both items, I set the paperweight inside the votive container.

The result was amazing, even with most of the paperweight below the rim of the candleholder. While still on the phone, I flipped the candleholder upside down and set the paperweight in the concavity at the bottom of the candleholder. The result was stunning. The appearance of the combined items improved by an order of magnitude.

I spent the remainder of the weekend conducting experiments that involved assembling combinations of decorative glass items and glass crystal containers into display arrangements. Though some arrangements were more interesting than others, every stable arrangement produced an improvement in appearance.

Moderately unstable arrangements were often more interesting, but they needed something to help keep the containers stay in place. To avoid gluing anything together while I was still experimenting, I cut holes in foam cushions and set the containers in the holes to fix their orientation.

It became apparent that a major reason for the improvement in appearance was that the clarity of the crystal containers allowed available light from the room to impinge upon the decorative glass from all directions.

I could use glass crystal containers as display apparatus that improved the optical presentation of the glass items while eliminating most problems with the display apparatus that I already owned. They minimize the need for special light sources.

With clear glass crystal containers, no tint is imparted. Crystal containers can also immobilize and orient decorative glass items obliquely or horizontally so that the viewer can see directly into the top of the decorative glass, even when the display is positioned at the eye level of the viewer.

During my experiments, I was able to elevate, orient, and immobilize all of my decorative glass items by using, serially, just two glass crystal containers. I used one candlestick for glass items ranging from the size of playing marbles up to medium sized paperweights, and one large pillar candleholder for items from medium-sized paperweights up to those as large as a doorstop and weighing as much as a bag of flour.

Crystal containers of varying size gradients may be used to achieve a terraced display, and I use heavier containers to ensure that displays do not become top-heavy.

Even if a crystal container display is scratched, it transmits light effectively and does not look as cheap as acrylic.

In addition to displays, the arrangements can also be used for decoration of residential and commercial establishments. Photographs of the displays have decorative value. The arrangements can be used as temporary decoration for weddings and formal occasions.

The list of benefits provided by this patent is:

(a) Displays that use crystal containers take maximum advantage of available light. The need for special lighting is minimized.

(b) A small number of glass crystal containers can be used to display a large number of sizes of decorative glass items.

(c) A small number of glass crystal containers can be used to display a large number of shapes decorative glass items.

(d) It becomes easy to position decorative glass items at multiple angles for maximum benefit of the viewer. It is possible to view the tops of items, even when they are at eye level.

(e) Reciprocally, displayed items complete unused containers, such that the appearance of emptiness is removed. Crystal display containers never have to be empty.

(f) By using decorative glass items to complete containers, contents do not wilt or spoil.

(g) By using decorative glass items to complete containers, contents are never used up.

(h) Arrangements of decorative glass and crystal provide unquantifiable decorative advantages that are always more than the sum of the parts.

(i) Display arrangements increase decorative interest by appearing to become other things. For instance, fiber optic marbles became the flames in candlesticks. Marbles above inverted glasses become the heads of people.

(j) Decorative items give the illusion of floating on air when they rest above large thick containers.

(k) Returning to where this all started, arrangements of decorative glass items and glass crystal containers save space.

(l) Multiple containers may be stacked to form an infinite variety of displays.

(m) Components of the arrangements can be easily reclaimed for their original purposes.

### SUMMARY

In accordance with this patent, a display apparatus for decorative glass items comprises a glass crystal container or a plurality of glass crystal containers.

### DRAWINGS—FIGURES

FIGS. 1A and 1B show the simplest method of creating an arrangement.

FIG. 2 shows how containers may be inverted.

FIG. 3 shows stacking of three different types of containers.

FIGS. 4A and 4B show side and perspective views of an assembly cushion stabilizing an arrangement.

FIG. 5 shows a pair of horizontal containers.

FIG. 6 shows a fiber optic egg replacing a candle.

FIGS. 7A, 7B, and 7C show upright, horizontal, and oblique orientation of a paperweight.

FIG. 8 shows stacking of two similar containers.

FIG. 9 shows a terraced presentation.

FIGS. 10A and 10B show views of an oblique arrangement.

### DRAWINGS—REFERENCE NUMBERS

| | | | |
|---|---|---|---|
| 20 | Conical glass item | 22 | Pillar candleholder |
| 24 | Irregularly shaped item | 26 | Votive candleholder |
| 28 | Decorative bead | 30 | Flattened globe |
| 32 | Candy dish | 34 | Coaster |
| 36 | Rocking votive holder | 38 | Rhomboid candlesticks |
| 39 | Center opening of assembly | | |
| | cushion | | |
| 40 | Assembly cushion | 42 | Fiber optic marble |
| 43 | Bud vase | 44 | Opening of bud vase |
| 45 | Back of bud vase, bottom of the | | |
| | arrangement | | |
| 46 | Fiber optic egg | | |
| 48 | Taper candlestick | 50 | Cup-shaped paperweight |
| 52 | Tall pillar candleholder | 54 | Pillow-shaped paperweight |
| 56 | Shot glass | 58 | Highball glass |
| 60 | Rim of candleholder | 62 | Concavity in votive |
| 64 | Concavity in coaster | 66 | Small marble |
| 68 | Decorative ridges | 70 | Indentations in surface |
| 72 | Decorative fabric | 74 | Pillar receptacle |
| 76 | Air hole in decorative item | 78 | Etching lines |
| 80 | Large glass pyramid | 82 | Inverted tumbler |
| 84 | Medium glass pyramid | 86 | Inverted water glass |
| 88 | Small glass pyramid | 90 | Inverted juice glass |
| 92 | Inverted bowl | 94 | Shallow bowl |
| 96 | Barrel-shaped glass item | | |

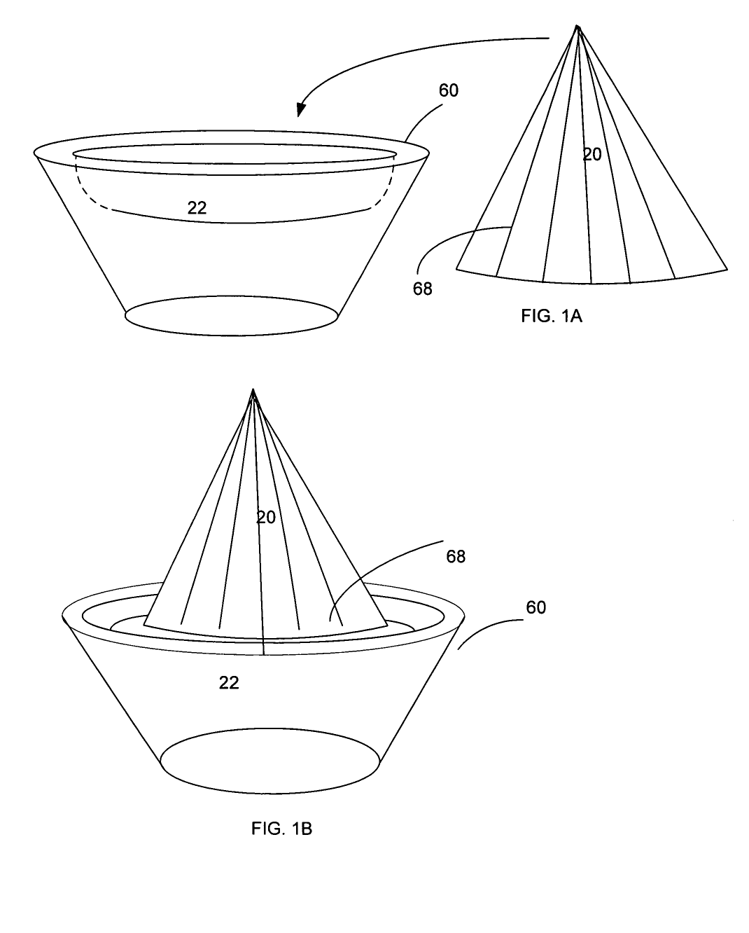

### DETAILED DESCRIPTION—FIGS. 1A AND 1B PREFERRED EMBODIMENT

FIGS. 1A and 1B show the simplest embodiment, demonstrating how the method in this application produces unusual and beneficial arrangements for display of decorative glass items. In FIG. 1A, I place a cone shaped decorative glass item 20 with ridges 68 within the rim 60 of a crystal pillar candleholder 22.

I elevate the decorative item within the crystal container to allow additional light to pass both through and around the cone. No additional lighting supply is needed. Additional light enhances the cone's appearance. The candleholder protects the base of the cone. The candleholder is no longer empty. The arrangement saves space for those who need it.

A surprising outcome is that the resulting arrangement becomes more than the sum of the parts. The difference is easily seen, even in a black and white line drawing. FIG. 1B encourages the imagination to interpret the arrangement. Consider a tribal habitation, the tip of an iceberg, or a toy sailboat.

The unexpected improvement in appearance occurs when both items in the arrangement are silicon based.

The container must be glass crystal. The crystal for the container must be internally clear and colorless. The exterior of containers, though usually clear and smooth, may include frosted, etched, or molded surfaces.

FIGS. 1A and 1B present a candleholder from the list of possible containers that includes crystal candlesticks, candleholders, vases, bowls, saucers, drinking vessels, vessels for serving liquids, coasters, and bottle holders.

The formula for the decorative glass item may include any constituents that its creator deems appropriate. The item may be any color, shape, or size. One restriction is that for proper balance, 67 percent of the weight of the decorative item should fit above the widest part of the chosen container.

The list of decorative glass items includes art glass in general, paperweights, door stops, hand coolers, laser-etched crystal, marbles of regular glass and fiber optic glass, eggs of regular glass and fiber optic glass, crystal beads, and crystal pendants.

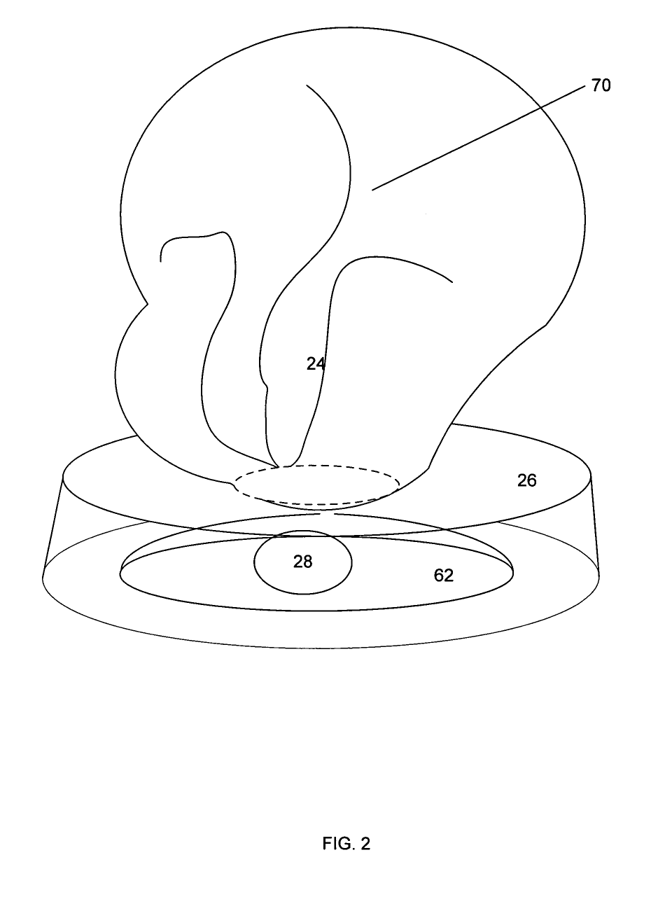

### FIGS. 2-9—ADDITIONAL ARRANGEMENTS

The arrangements in FIG. 2 through FIG. 9 provide all the benefits described for FIG. 1B, with additions.

FIG. 2 shows how an inverted crystal container may be used in a display arrangement. The votive candleholder 26 still provides advantages like the pillar candleholder in FIG. 1B. I placed the crystal bead 28 within the hollow 62 of the inverted candleholder to show how it adds decorative interest. The benefit of the inverted crystal container over easels, terraces, compartmentalized shelves, and flat, or elevated rings is that it easily handles irregular shapes 24 and indentations 70 in those shapes.

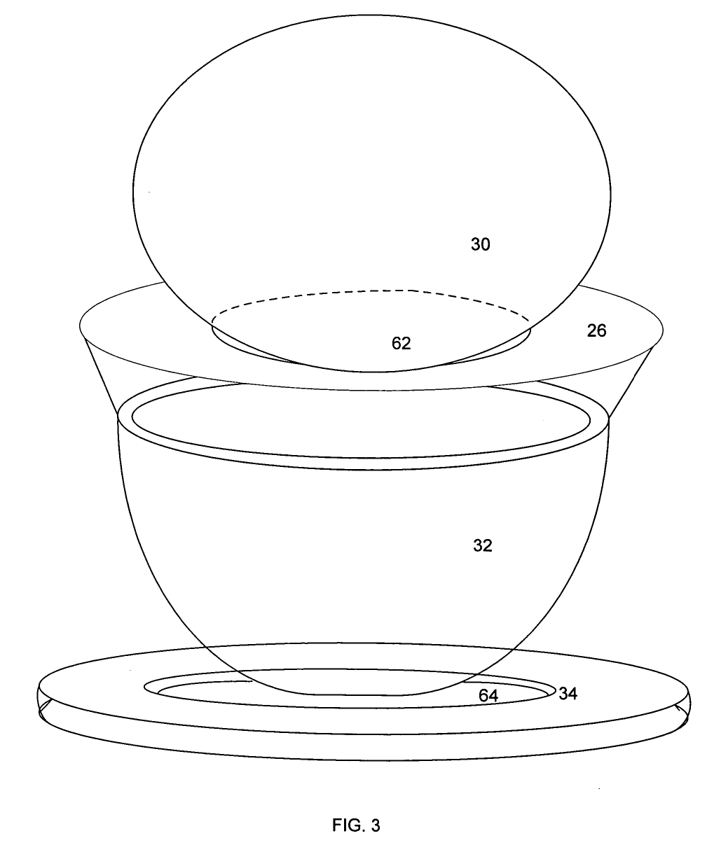

FIG. 3 shows how combining simple versions of differing containers can add variety to the display of a simple glass item. A votive 26, a bowl 32, and a coaster 34 add interest to the flattened globe 30. The globe 30 is elevated and immobilized within the concavity 62 of the votive 26. The bowl sets in the concavity of the coaster 64. The arrangement provides all the benefits described for FIG. 1B. For variety, a designer could:

(a) Place the coaster 34 between the bowl 32 and the votive 26.

(b) Invert the bowl 32.

(c) Place the bowl 32 within the votive 26 and the globe 30 in the bowl 32.

(d) Invert the votive 26 and set the bowl 32 with the globe 30 on top.

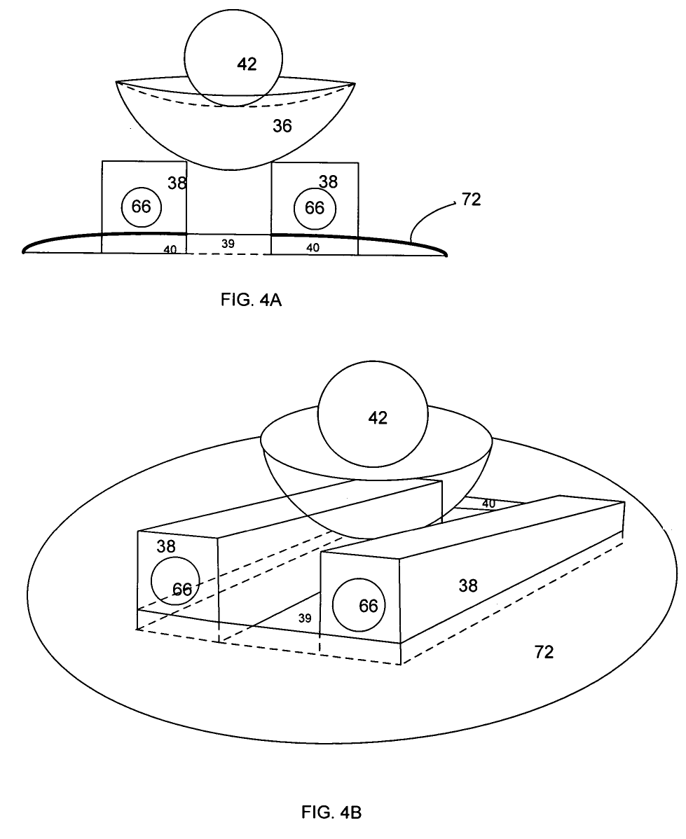

FIG. 4A shows a side view of how an assembly cushion 40 fixes the position of containers for an attention getting display. FIG. 4B provides the perspective view. In this example, rhomboid taper candlesticks 38 are positioned on their sides and elevate a rocking candleholder 36. The candleholder 36 is round on the bottom and holds a fiber optic marble 42 in the concavity on top. The marble simulates a flame. Without assistance, the weight of the candleholder 36 and marble 42 push the candlesticks 38 apart and the arrangement collapses.

To correct this problem, the assembly cushion 40 has an opening in its center 39 that is the width of three candlesticks 38 and is exactly the length of one candlestick 38. When the cushion 40 is placed around the candlesticks 38, they do not slide apart. The resulting arrangement appears to be a bowl with a colored flame floating in mid air.

Small marbles 66 fill the candle holes and are the same color as the larger marble 42 within the candleholder 36. They complete the arrangement. A high-quality fabric covering 72 for the cushion 40 contributes an air of elegance to the display.

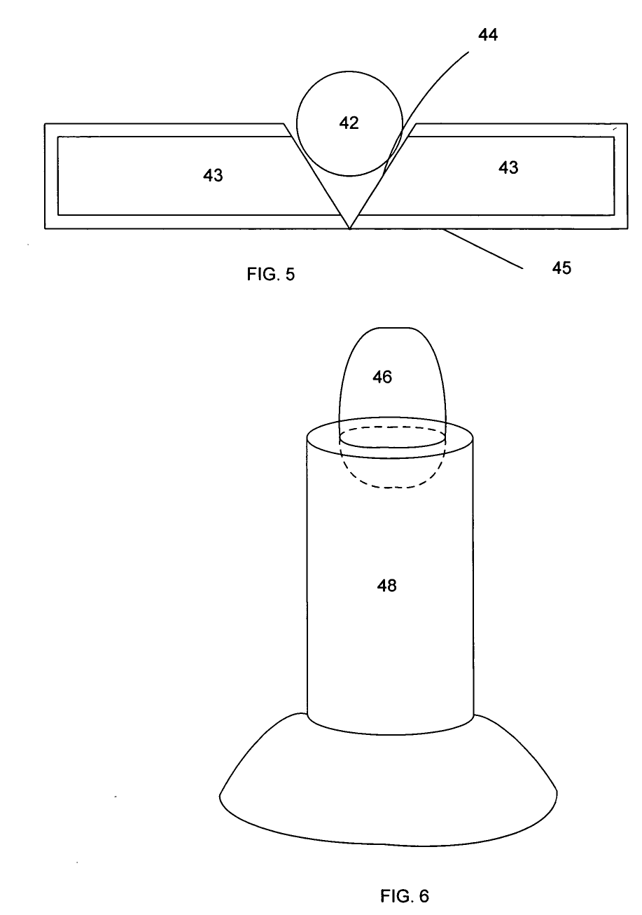

FIG. 5 shows another simple, but interesting arrangement. Two bud vases 43 lie horizontally with a marble 42 positioned between them. The diameter of the marble 42 is slightly larger than the width of the openings of the vases 44. The marble is suspended above the backs of the vases 45 that now form the bottom of the arrangement. Because the marble is much lighter than the vases 43, they maintain their positions without the assistance of an assembly cushion.

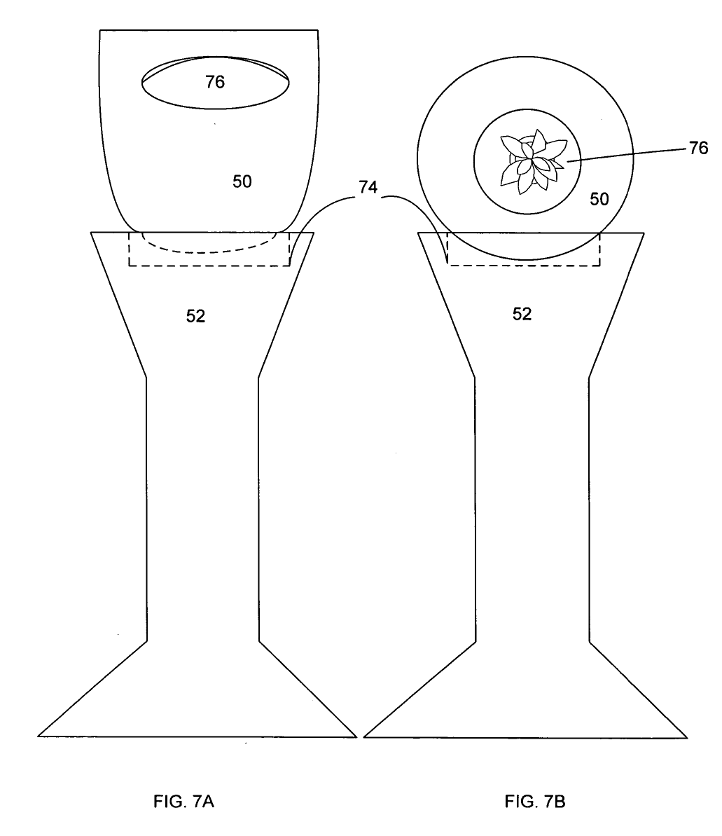

FIG. 6 shows a small taper candlestick 48 with a fiber optic egg 46 in place of a candle. Orange, yellow, or white eggs prove to be excellent stand-ins for candles, they glow with internal light produced by the bundles of optical fibers, and they never burn.

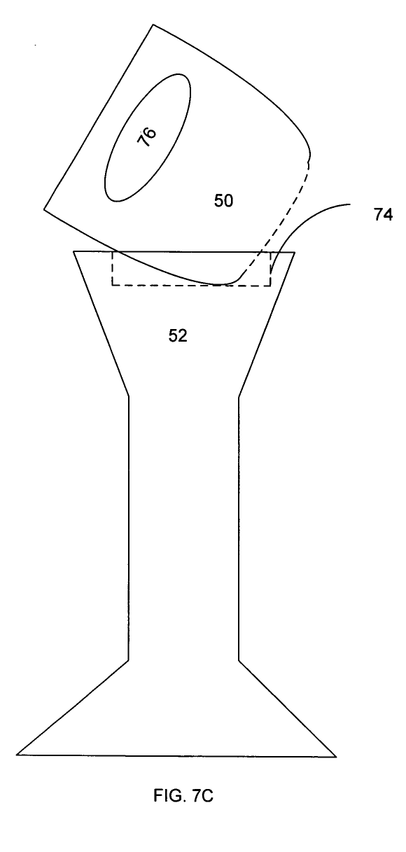

FIG. 7 shows a benefit that is available with the use of crystal containers that is hardly available with any other type of display apparatus. That is, the ability to see straight into the tops of oval-shaped glass solids while they are setting within shelving displays, often behind glass. Since most paperweights are round, most are displayed on shelves, and the best quality ones are behind protective barriers, this is a boon.

Votive holders, multi-purpose pillars holders, and small crystal bowls handle the widest range of sizes, but even taper candlesticks or drinking vessels will handle a specific range of items safely.

The method is elegant in its simplicity. In FIG. 7A a cup-shaped paperweight 50 with an apparently plain elliptical air hole 76 near the top sets upright in the opening 74 of a tall pillar candleholder 52.

FIG. 7B shows the paperweight 50 on its side with the top facing the viewer. The rim of the pillar opening 74 keeps the paperweight from rolling and the viewer can now clearly see the floral design 76 on the top of the bubble.

FIG. 7C has same container presenting the paperweight obliquely for display at intermediate elevations.

On any flat surface without the pillar candleholder, the item would roll, it would tilt precariously on easels, and it would either dip into or roll off rings.

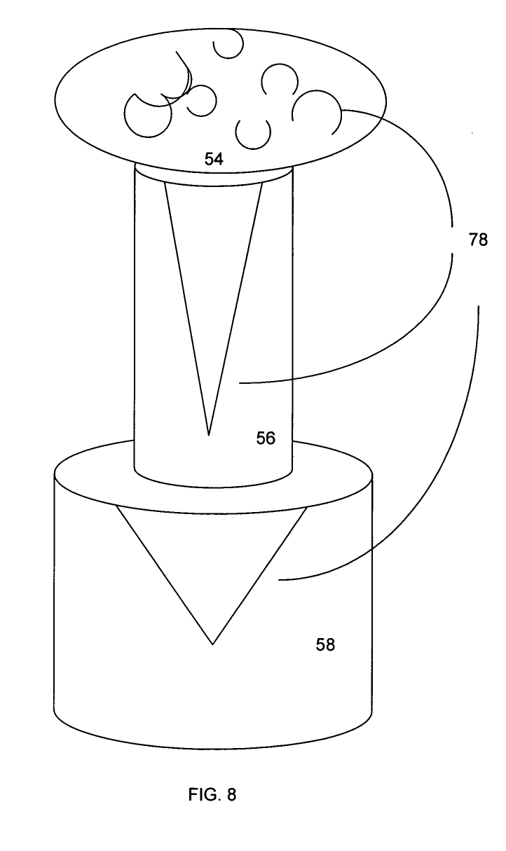

FIG. 8 shows the interesting affect produced by stacking a pillow shaped paperweight 54 with etchings 78 atop paired highball 58 and shot glasses 56.

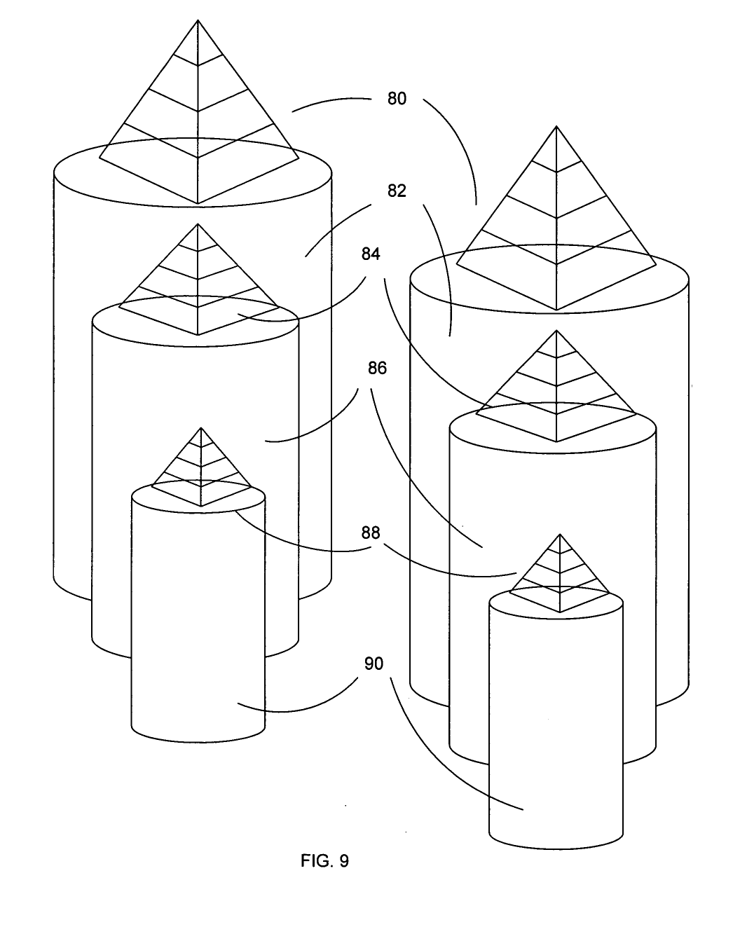

FIG. 9 shows pyramids (80, 84, 88) in different sizes presented in a terraced arrangement using different sizes of crystal drinking vessels (82, 86, 90).

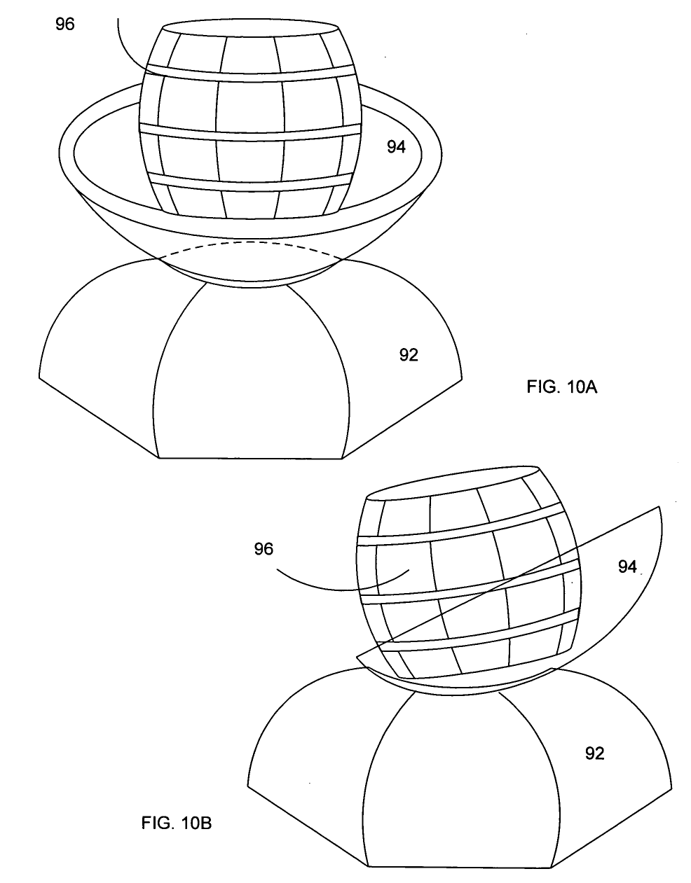

FIGS. 10A and 10B show another design option. A shallow bowl 94 is placed obliquely in the concavity of an inverted bowl 92. This supports oblique display of the decorative glass barrel-shaped 96 item and helps to prevent it from rolling off the lower bowl.

### ADVANTAGES

The measurable benefits of using crystal containers as display apparatus, with occasional assistance from assembly cushions, are that it:

(a) Minimizes the need for special lighting.

(b) Allows the display of a wide range of shapes and sizes of decorative glass with relative few crystal containers.

(c) Allows design variety with only a few display containers.

(d) Allows sophisticated designs using relatively inexpensive materials.

(e) Allows horizontal display of round decorative items that is almost impossible with current types of display.

(f) Helps to protect the glass items being displayed.

(g) Saves space.

Immeasurable benefits are that:

(a) Arrangements of decorative glass items and crystal containers always look better than the individual items.

(b) Many arrangements stimulate the imagination and appear to metamorphose into other people, places, and things.

(c) Decorative glass items complete empty containers, thereby minimizing the need for artificial flowers, fruit, etc.

1. A method for assembling glass crystal containers and decorative glass items as a means of display, decoration, and ornamentation.

2. In claim 1, said containers are means of immobilizing and orienting a plurality of said items simultaneously.

3. In claim 1, any flat surface of said containers is a means of supporting said glass item if it is capable of immobilizing said glass item.

4. In claim 1, a plurality of said containers is a means of immobilizing and orienting said glass items.

5. In claim 1, any concave surface of said glass crystal container is a means of immobilizing and orienting said glass item.

6. In claim 1, said container may comprise a candleholder, candlestick, vase, bowl, saucer, drinking vessel, a vessel for serving liquids, a coaster, and bottle holder.

7. In claim 1, vertical, oblique, horizontal, and upside down orientation relative to the usual placement for said container is a means of providing display and decorative value.

8. In claim 1, vertical, oblique, and horizontal orientation relative to the usual placement for said glass item is a means of providing display and decorative value.

9. In claim 1, stacking a plurality of said containers into a container stack is a means of adding variety to displays.

10. In claim 1, said glass items may comprise a paperweight, doorstop, hand cooler, laser-etched crystal, glass art in general, a marble of regular glass and fiber optic glass, an egg of regular glass and fiber optic glass, a crystal bead, and a crystal pendant.

11. A device that provides a means of fixing the position and orientation of said glass crystal containers and said container stacks.

12. In claim 11, said device will be comprised of a flexible assembly cushion.

13. In claim 11, said cushion is comprised of a circular torus, oval, rectangular, U-shaped, and tubular solid form.

14. In claim 11, said cushion will have an opening in the center with an area equal to least one base of said container.

15. In claim 11, said cushion will be covered on its top surface with a closely woven, opaque, non-reflective, cloth fabric.
